(19) United States
(12) Patent Application Publication
(10) Pub. No.: US 2012/0180674 A1
(43) Pub. Date: Jul. 19, 2012

(54) Grill Insert

(76) Inventors: Bradley Lewis, Brighton, MI (US); Scott Lewis, Brighton, MI (US)

(21) Appl. No.: 13/350,408

(22) Filed: Jan. 13, 2012

Related U.S. Application Data
(63) Continuation-in-part of application No. 29/406,566, filed on Nov. 16, 2011.
(60) Provisional application No. 61/432,244, filed on Jan. 13, 2011.

(51) Int. Cl. A47J 36/20

(52) U.S. Cl. 99/445

(57) ABSTRACT

A grill insert may be placed within a pan or other cooking implement to hold food above a heat source and to keep fluids from contacting the food. As food cooks upon the grill insert, fluids may drain into lower chambers or reservoirs. The grill rods are shaped to focus heat upon the food and to maximize space for holding fluids released during the cooking process. The form of the grill insert may have an underside with a center void so as to conform to a typical pan having a raised center portion.

### RELATED PATENT APPLICATION AND INCORPORATION BY REFERENCE

This is a utility application based upon U.S. patent application Ser. No. 61/432,244 filed on Dec. Jan. 13, 2011 and U.S. design patent application 29/406,566 filed on Nov. 16, 2011. These related applications are incorporated herein by reference and made a part of this application. If any conflict arises between the disclosure of the invention in this utility application and that in the related applications, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

1. Field of the Invention

The invention generally relates to cooking tools. More particularly, the invention relates to means of elevating food away from food fluids while cooking in a pan.

2. Description of the Related Art

In the related art of barbequing, food is placed upon a grill and heat rises from below to cook the food. As the food cooks, fluids from the food drip down into the fire and briquette area. The drainage of food fluids improves the flavor of the food, keeps liquefied fat off of the food and provides food flavoring as the food fluids drip upon hot ceramic pieces, charcoal or wet wood. A traditional barbeque requires on open flame and room for drippings to drain away from the cooked food and then vaporize, steaming back to the food and imparting flavor. Thus, a traditional barbeque does not work indoors due to the excessive heat and smoke a traditional barbeque generates.

U.S. patent application Ser. No. 09/738,762 by Borner discloses a grilling device for a cooking device having a topside with depressions to receive fluids from cooked food.

U.S. Pat. No. 7,059,318 issued to Cornfield on Jun. 13, 2006 discloses a reversible cooking plate having a grilling surface.

The know prior art fails to provide effective grilling surfaces suitable for indoor use. Both Borner and Cornfield disclose standardized grill inserts with no artful means of allowing fluid to drain away from the food.

### BRIEF SUMMARY OF THE INVENTION

The present invention overcomes shortfalls in the related art by presenting an unobvious and unique combination, configuration and use of grilling components that have achieved unexpected results in maximizing grate to food cooking surfaces and maximizing room for fluid storage away from the cooked food. The grate shapes used are in an “A” shape, providing a relatively narrow or focused area for food contact and heat transfer and widening at the bottom, allowing for greater heated surface area to evaporate food fluids such as grease.

The present invention also overcomes shortfalls in the art by having rounded grates at the perimeter of the device so as to again maximize space for food fluids. In one contemplated embodiment, a bottom center circular area is modified to hold even greater portions of food fluid. In another variation, perimeter pools hold expanded sections of fluid to the perimeter of the device.

### BRIEF DESCRIPTION OF THE DRAWINGS

FIG. 1 is a front view of a grill insert

FIG. 2 is a rear view of a grill insert

FIG. 3 is a side view of a grill insert

FIG. 4 is another side view of a grill insert

FIG. 5 is an isometric view of a grill insert

FIG. 6 is a top view of a grill insert

FIG. 7 is a bottom view of a grill insert

### REFERENCE NUMERALS IN THE DRAWINGS.

100 a grill insert in general

101 a top surface of a grill insert

120 a center trough found on the bottom of a grill insert

130 bottom side of a grill insert

140 concave outside section of perimeter curved grill bars 145

145 perimeter curved grill bars

150 inside straight sections of perimeter grill bars 145

165 a bottom portion of a center grill bar 171

167 an “A” angled vertical wall of a typical center grill bar 171

170 center grill bars found in between perimeter grill bars 145

171 a typical center grill bar

172 a top surface of a grill bar, the top surface sometimes in direct contact with food

173 curved ends of typical center grill bars 170

200 grill voids defined by center grill bars 170

220 a perimeter pool void

300 insertion voids adjacent to either straight edge, the void sometimes used for moving the grill insert in or out of a pan

400 perimeter deck cooking surface

500 straight edges on either side of a grill insert

501 curved edges on either side of grill insert

700 a circular bottom void area defined upon the bottom side

710 center sections a circular center void area defined upon the bottom side of three or more of the center bar grills 171

800 top surface of center bar grills

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

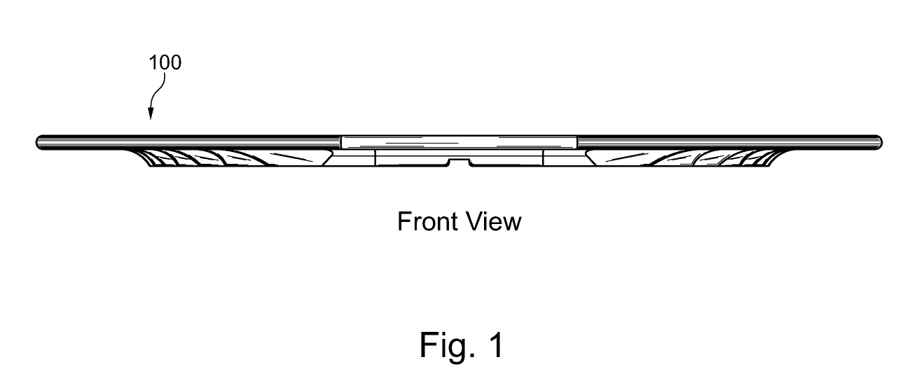

FIG. 1 presents a front view of a grill insert 100 in general.

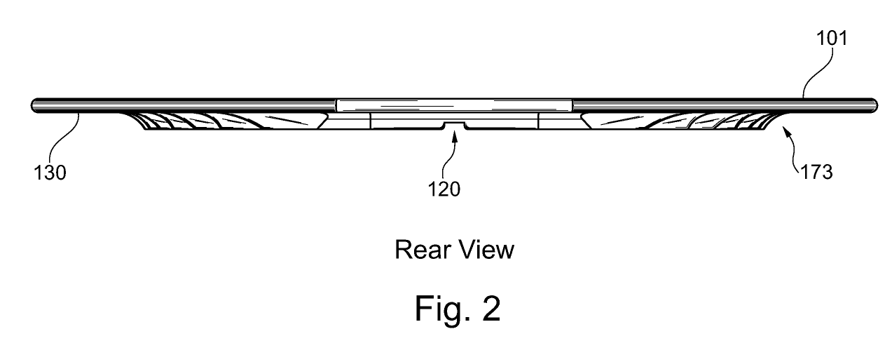

FIG. 2 presents a symmetrical rear view. A top side 100 is found above a bottom side 130. A center trough 120 is found on the bottom side. Outside sections 140 of grill bars are shown curving toward the center.

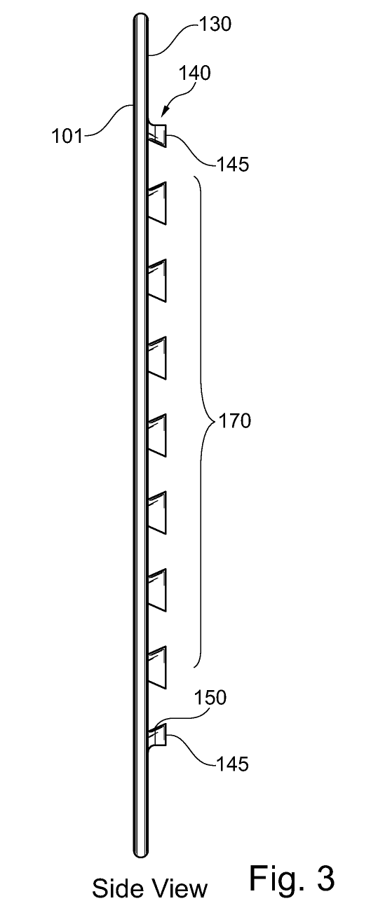

FIG. 3 presents a view of two perimeter bar grills 145 flanking a plurality of center bar grills 170. The two perimeter bar grills 145 each have an inner straight side 150 and a concave outside section 140.

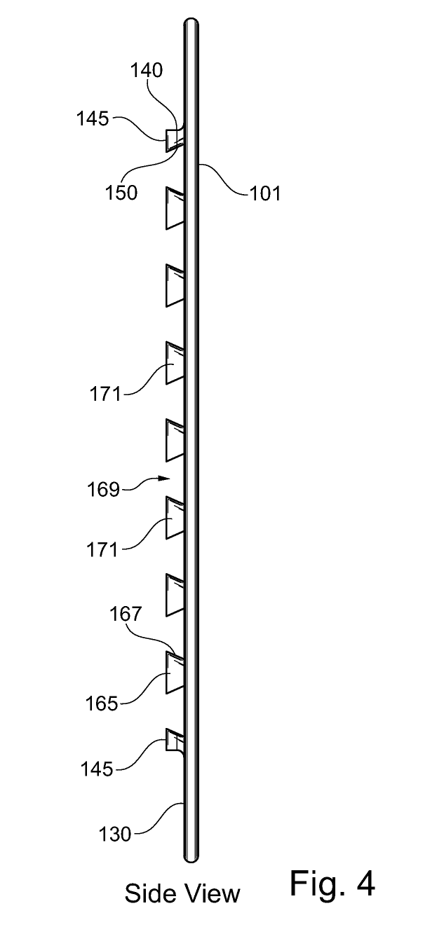

FIG. 4 presents a grill insert having a bottom side 130 and a top side 101. Upon the bottom side there are two perimeter curved grill bars 145 and several typical center grill bars 171. Between the center grill bars “V” shaped voids 169 are defined by the vertical walls 167 of the center grill bars 171. The bottom surfaces 165 of the center grill bars 171 are wider as compared to their top surfaces.

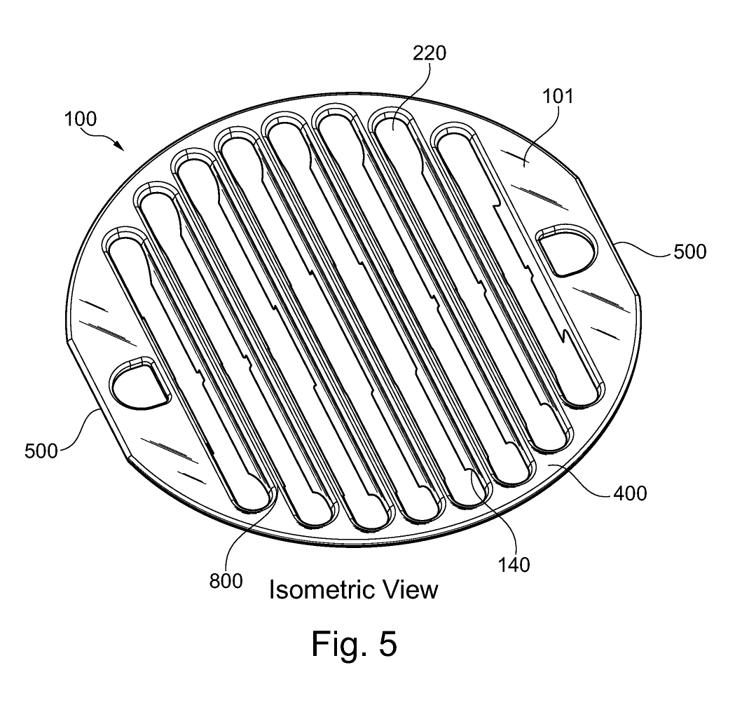

FIG. 5 presents an isometric view of a grill insert. The tilted nature of the figure allows a view of concave outside section 140 of perimeter curved grill bars. On either side of the center grill bars 171 perimeter pool voids 220 are defined. A grill insert 100 is shown generally with narrow top surfaces 800 of each center grill bar. At the perimeter of the top deck 101 or top surface is a perimeter deck cooking surface 400.

In normal use the grill insert 100 is placed within a pan and food to be cooked is placed upon the top surfaces 800 of the grill bars. Fluid cooked out of the food drains down the walls 167 of the grill bars and through voids 220 between the grill bars. The fluid then collects at the bottom of the pan

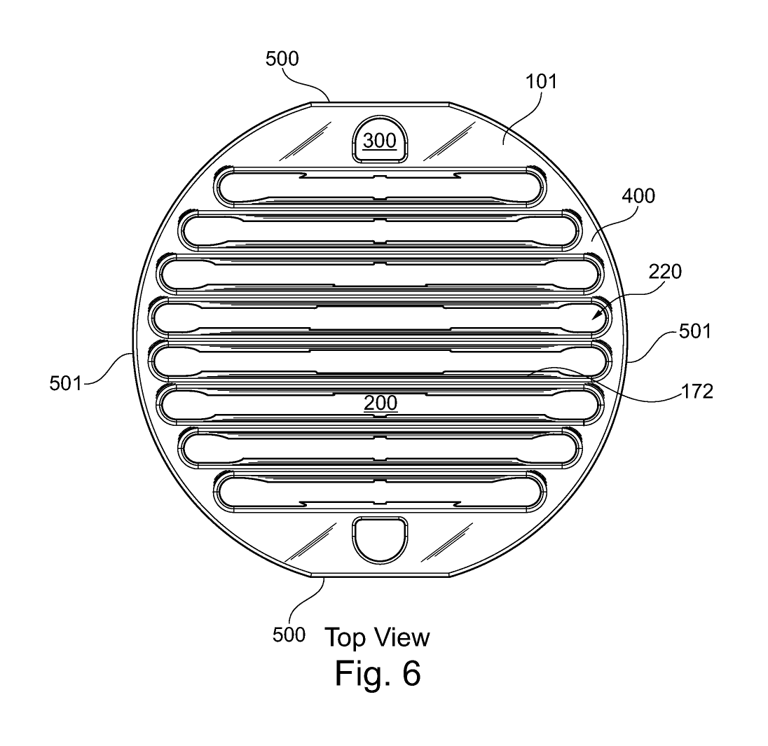

FIG. 6 depicts a top view of a grill insert with insertion voids 300 adjacent to either straight edge 500. The insertion voids 300 are sometimes used to facilitate the insertion or removal of the grill insert into or out of a pan.

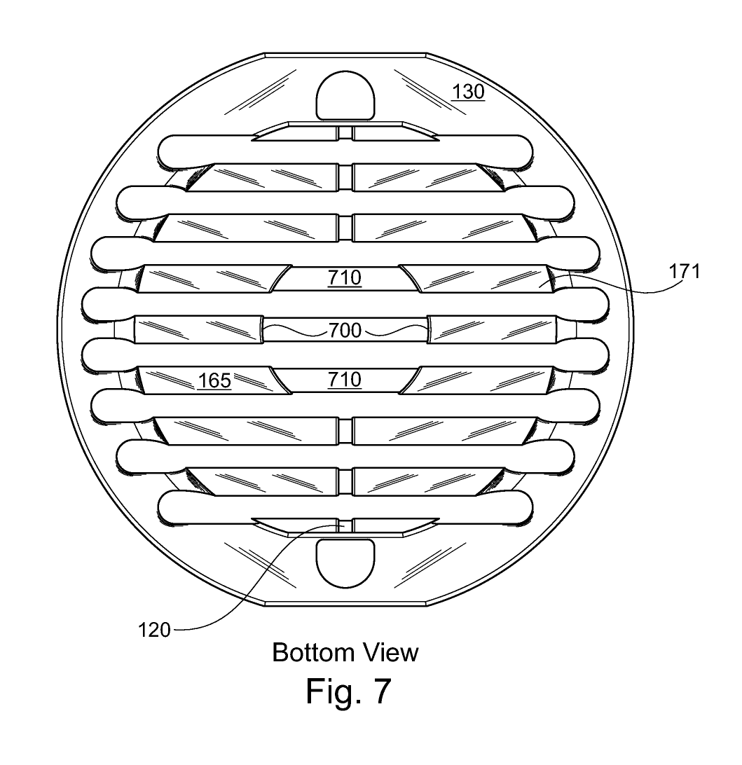

FIG. 7 depicts a bottom view of a grill insert. The bottom side 130 is shown with a center trough 120 and a circular center void area 710 defined upon the bottom side of three or more of the center bar grills 171. The bottom circular center void area 710 provides extra space for the storage, heating and evaporation of food fluid.

One of the advantages of the invention is that the center void area defined within the bottom surface accommodates a typical peak often found in the center of frying pans. Thus, the bottom center void often allows the grill insert to sit flat upon a grill and allows the food fluids to flow outwardly toward the perimeter of the grill insert.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

Embodiments of the disclosed grill insert include:

1. A device 100 for grilling food in a pan, the device comprising:

a) a bottom side 130 comprising two perimeter curved grill bars 145 flanking a plurality of center grill bars 170, with three or more center bar grills 170 defining a center circular bottom void area 700;

b) the center circular bottom void area 700 having a plurality of grill voids 200, the grill voids being defined by a plurality of the center grill bars 170;

c) the two perimeter curved grill bars 145 each having a concave outside sections 140 and inside straight sections 150;

d) the plurality of center grill bars 170 having two “A” angled 167 vertical walls longitudinally and curved ends 173, the plurality of center grill bars having bottom surfaces 165 of greater width as compared to top surfaces 800 of the plurality of center grill bars;

e) the grill insert having a top side 101 and two straight edges 500 on either side of two curved edges 501, the top side defining two insertion voids 300 located adjacent to the two straight edges 500; and

f) the center grill bars having top sides 800, the center grill bars defining grill voids 200 with the center grill bars further defining perimeter pool voids 220.

What is claimed is:

1. A device for grilling food in a pan, the device comprising:
a) a bottom side comprising two perimeter curved grill bars flanking a plurality of center grill bars, with three or more center bar grills defining a center circular bottom void area;
b) the center circular bottom void area having a plurality of grill voids, the grill voids being defined by a plurality of the center grill bars;
c) the two perimeter curved grill bars each having a concave outside sections and inside straight sections;
d) the plurality of center grill bars having two “A” angled vertical walls longitudinally and curved ends, the plurality of center grill bars having bottom surfaces of greater width as compared to top surfaces of the plurality of center grill bars;
e) the grill insert having a top side and two straight edges on either side of two curved edges, the top side defining two insertion voids located adjacent to the two straight edges; and
f) the center grill bars having top sides, the center grill bars defining grill voids with the center grill bars further defining perimeter pool voids.

2. The device of claim 1 further including a center trough defined by the bottom of the device.
